(19) United States
(12) Patent Application Publication
(10) Pub. No.: US 2014/0053920 A1
(43) Pub. Date: Feb. 27, 2014

(54) FAIL SAFE HOT WATER TANK

(71) Applicants: John George Vasilakis, South Euclid, OH (US); Tom Galey, Grand River, OH (US)

(72) Inventors: John George Vasilakis, South Euclid, OH (US); Tom Galey, Grand River, OH (US)

(21) Appl. No.: 13/591,178

(22) Filed: Aug. 21, 2012

(51) Int. Cl. F16K 17/00

(52) U.S. Cl. 137/456

(57) ABSTRACT

A hot water tank has an electronic circuit on the tank that monitors the incoming water flow and the outgoing water flow. If the sensors in the circuit sense incoming water and no outgoing water flow, then there must be a problem and the system will automatically shut off the incoming water to the tank. Current hot water tanks that do not monitor the flow of water into and out of the tank and, therefore, if the tank ruptures, water is left to flow out of the tank and flood the home. With the system of the present invention, the flow in and out of the water tank is measured and incoming water can be shut off in the event where incoming flow exceeds outgoing flow.

### BACKGROUND OF THE INVENTION

The present invention relates to hot water tanks and, more particularly, to a fail-safe hot water tank that will shut off the incoming water when the hot water tank ruptures.

When a home hot water tank gets old, they have a tendency to rupture, leaving the incoming water to the tank to flood the home until someone turns off the water supply to the tank. There are currently no fail-safe systems to react in case of a hot water tank rupture.

As can be seen, there is a need for a fail-safe hot water tank that will shut off the incoming water when the hot water tank ruptures.

### SUMMARY OF THE INVENTION

In one aspect of the present invention, a system for controlling a flow into a device comprises a first flow sensor detecting flow into the device; a second flow sensor detecting flow out of the device; a shut off valve operable to close when a first flow sensed by the first flow sensor is greater than a second flow sensed by the second flow sensor for a predetermined period of time and over a predetermined flow volume; an alarm operable to issue an alert when the shut off valve closes; an on/off switch operable to turn the system on and off; and a reset button.

In another aspect of the present invention, a system for controlling a water flow into a hot water heater comprises a first flow sensor detecting flow into the device; a second flow sensor detecting flow out of the device; a solenoid shut off valve operable to close when a first flow sensed by the first flow sensor is greater than a second flow sensed by the second flow sensor for a predetermined period of time, controlled by a time delay relay, and over a predetermined flow volume; an alarm operable to issue an alert when the shut off valve closes; an on/off switch operable to turn the system on and off; and a reset button.

These and other features, aspects and advantages of the present invention will become better understood with reference to the following drawings, description and claims.

### BRIEF DESCRIPTION OF THE DRAWINGS

FIG. 1 is a perspective view of a hot water tank having a fail-safe control to turn off incoming water in case of a tank rupture, according to an exemplary embodiment of the present invention; and

FIG. 2 is an electrical schematic diagram showing the control system for controlling the fail-safe control of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hot water tank that has an electronic circuit on the tank that monitors the incoming water flow and the outgoing water flow. If the sensors in the circuit sense incoming water and no outgoing water flow, then there must be a problem and the system will automatically shut off the incoming water to the tank. Current hot water tanks that do not monitor the flow of water into and out of the tank and, therefore, if the tank ruptures, water is left to flow out of the tank and flood the home. With the system of the present invention, the flow in and out of the water tank is measured and incoming water can be shut off in the event where incoming flow exceeds outgoing flow.

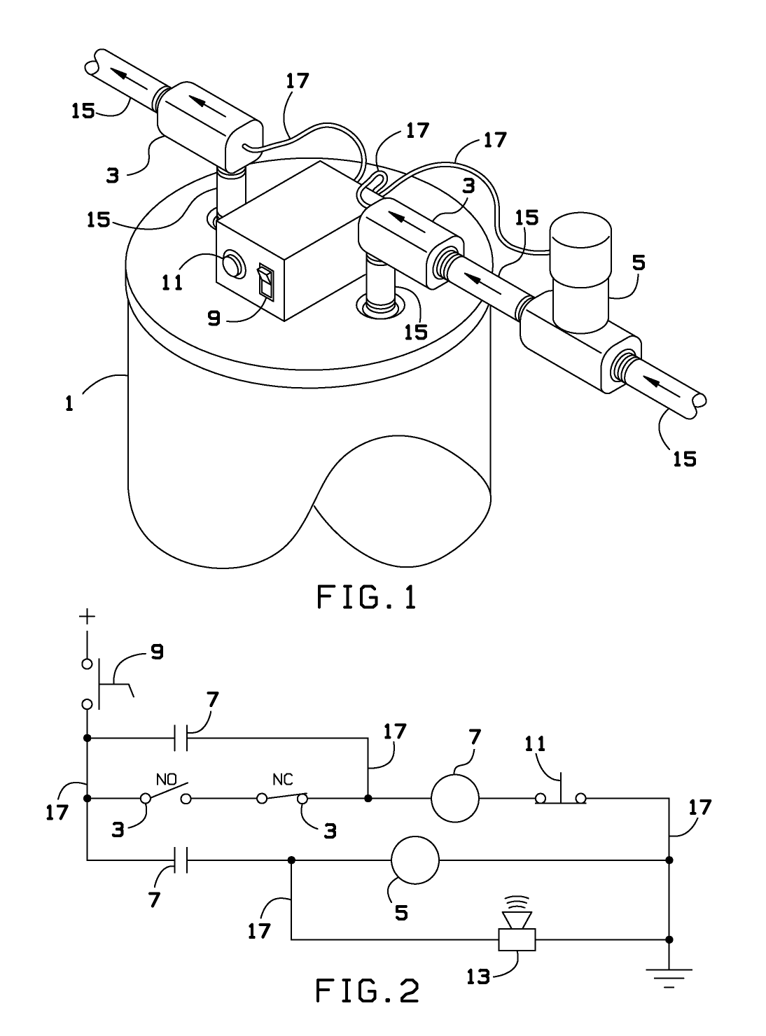

Referring now to FIGS. 1 and 2, a water tank 1 can be, for example, a hot water tank that heats up water for household or business use. This could be a tank type or a tank-less type, gas or electric, for example. Flow sensors 3 can be disposed on water pipes 15 that supply water into and out of the water tank 1. The flow sensors 3 monitor the flow of water coming into and out of the water tank 1.

A solenoid controlled shut off valve 5 can be disposed on the water pipe 15 supplying water to the water tank 1. The valve 5 can be actuated by an electric solenoid. When electricity is applied to the solenoid, it creates a magnetic field that pulls the valve closed. Typically, the valve 5 is a normally open valve.

A time delay relay 7 can have two normally open contacts. When electricity is applied to the coil of this relay, it has a set time, such as about 2-5 seconds, before tripping the two sets of contacts. While the circuit of FIG. 2 has two relays 7, a single relay could be used in an alternate circuit.

An on/off switch 9 can be used to control the system of the present invention. When filling the water tank 1 from empty, the system must be in the off position so it will not trip, allowing water to come into the water tank 1. Similarly, if a user need to take water off a lower drain of a water tank (as suggested for periodic maintenance of many water tanks), by turning the on/off switch 9 off, this can be achieved without activating the system and turning off the incoming water. Also, if the system was to have a malfunction, the on/off switch 9 can be used to override the system to allow hot water to be delivered from the water tank.

A reset push button 11 can be used to reset the system after activation thereof. The reset push button 11 can be a momentary normally closed push button (push to break) that will break the connection of the latched shut off water state just in case there is a glitch that trips the circuit. This will let water into the tank, even if there is a problem, until the button is released.

An alarm buzzer 13, optionally including a light, can provide an audible and visual alarm to let someone know there is a problem with the water tank 1.

Wiring 17 can be provided to electrically connect the components of the circuitry. For example, the wiring 17 can connect the flow sensor switches 3 with the shut-off valve 5, the on/off switch 9 and the reset push button 11. As shown in FIG. 2, the wiring 17 can connect various components. The wiring 17 can be any conductive material, such as copper, having a wire gauge appropriate for the intended application.

The flow of water into and out of the water tank 1 is monitored by the two flow sensor switches 3 that are wired in series with each other. One can be a normally open switch and the other a normally closed switch. When water starts to flow in to the tank, it will trip the inflow sensor, completing the circuit. At this time, the time delay relay 7 starts counting down.

In a normal working condition, water will be flowing out of the tank at just about the same time as it starts coming into it, tripping the outgoing flow sensor switch 3, breaking the circuit and stopping the relay from counting down. This causes the water tank flow just like an everyday tank. However, if the hot water tank was to rupture, the incoming water will trip the flow sensor switch on the incoming water but the outgoing water sensor will not be tripped and starts the time delay relay to count down, typically between about 2 and 5 seconds, after which the shut off valve 5 will shut down the flow of incoming water.

In some embodiments, when the shut off valve 5 trips, circuitry can be included to prevent a thermostat from trying to heat the water (or lack of water) in the tank, adding an additional safety feature to prevent overheating.

The system of the present invention could be made as a stand-alone unit or can be built in as part of the hot water tank, whether it is a tank or tankless type of system. The system of the present invention could be used on other devices in addition to a hot water heater. For example, the system of the present invention could be used on a washing machine or dishwasher, or just about any machine that has incoming water pressure or any device left unattended like a boiler system for heat. The system of the present invention could even be incorporated into a natural gas line, for example, and can be configured to shut down the natural gas lines that can conventionally cause an explosion if the gas lines get ripped apart from a tornado or earthquake.

It should be understood, of course, that the foregoing relates to exemplary embodiments of the invention and that modifications may be made without departing from the spirit and scope of the invention as set forth in the following claims.

What is claimed is:

1. A system for controlling a flow into a device, comprising:
a first flow sensor detecting flow into the device;
a second flow sensor detecting flow out of the device;
a shut off valve operable to close when a first flow sensed by the first flow sensor is greater than a second flow sensed by the second flow sensor for a predetermined period of time and over a predetermined flow volume;
an alarm operable to issue an alert when the shut off valve closes;
an on/off switch operable to turn the system on and off; and
a reset button.

2. The system of claim 1, wherein the device is a hot water heater.

3. The system of claim 1, wherein the shut off valve is a solenoid shut off valve.

4. The system of claim 1, wherein the predetermined period of time is from about 2 to about 5 seconds.

5. The system of claim 1, wherein the predetermined flow volume is 0.1 gallon per minute or less.

6. The system of claim 1, further comprising a time delay relay with two normally open contacts, the time delay relay adapted to control the predetermined period of time before closing the shut off valve.

7. The system of claim 1, wherein the alert includes an audible alarm and a light.

8. A system for controlling a water flow into a hot water heater, comprising:
a first flow sensor detecting flow into the device;
a second flow sensor detecting flow out of the device;
a solenoid shut off valve operable to close when a first flow sensed by the first flow sensor is greater than a second flow sensed by the second flow sensor for a predetermined period of time, controlled by a time delay relay, and over a predetermined flow volume;
an alarm operable to issue an alert when the shut off valve closes;
an on/off switch operable to turn the system on and off; and
a reset button.

9. The system of claim 8, wherein the predetermined period of time is from about 2 to about 5 seconds.

10. The system of claim 8, wherein the predetermined flow volume is 0.1 gallon per minute or less.

11. The system of claim 8, wherein the alert includes an audible alarm and a light.
